(19) United States
(12) Patent Application Publication
(10) Pub. No.: US 2015/0069975 A1
(43) Pub. Date: Mar. 12, 2015

(54) STAGGERING CHARGING BATTERIES

(71) Applicant: Lincoln Global, Inc., City of Industry, CA (US)

(72) Inventors: SAMIR F. FARAH, BROADVIEW HEIGHTS, OH (US); ANDREU MECKLER, MENTOR, OH (US)

(73) Assignee: Lincoln Global, Inc., City of Industry, CA (US)

(21) Appl. No.: 14/104,134

(22) Filed: Dec. 12, 2013

Related U.S. Application Data
(60) Provisional application No. 61/876,812, filed on Sep. 12, 2013.

(51) Int. Cl. H02J 7/00

(52) U.S. Cl. CPC H02J 7/0052
USPC 320/150

(57) ABSTRACT

The invention described herein generally pertains to batteries for a welding operation being managed by various staggering techniques. Particularly, various controllers or methodologies can stagger, rotate, or selectively activate and deactivate welding batteries to manage battery parameters or remain within constraints. For example, battery temperature can be monitored and controlled based on staggered charging or derating. In some embodiments, various controls can be integrated with (or methodologies applied to) batteries used in hybrid welders.

### CROSS-REFERENCE TO RELATED APPLICATIONS AND INCORPORATION BY REFERENCE

This U.S. patent application is a continuation of and claims the benefit of U.S. provisional patent application 61/876,812 filed on Sep. 12, 2013, which is incorporated herein by reference in its entirety.

### TECHNICAL FIELD

Devices, systems, and methods consistent with the invention relate generally to welding equipment, and more particularly, to batteries for powering welding equipment, and still more particularly to managing the charge and discharge of welding batteries according to various constraints and models.

### BACKGROUND OF THE INVENTION

Many devices including hybrid welders utilize batteries that operate best within specific temperature ranges. If a battery is not kept above and within a specified range, the battery may charge inefficiently, fail to supply adequate power, suffer from reduced longevity, and so forth. Use of the battery itself, through charge or discharge, can frequently be a cause of such temperature. In particular, the build-up of heat is complicated when several batteries are used in close proximity, both due to the increased amount of heat generated in a proximate area, and the batteries and accompanying structure may inhibit ventilation or other means of heat dissipation. While cooling systems may be integrated, cooling systems typically draw additional energy, and the only way to prevent such batteries from generating heat is to cease their use by stopping charging or disconnecting from a load.

### SUMMARY OF THE INVENTION

In accordance with the present invention, there is provided a method for controlling the charging of a plurality of batteries. The method can comprise charging at least one first battery in a battery charging sequence; monitoring a temperature of the at least one first battery of the battery charging sequence to provide a first battery temperature value; ceasing charging of the at least one first battery in response to the first battery temperature value being outside a charging temperature range; charging at least one second battery in a battery charging sequence in response to ceasing charging of the at least one first battery; monitoring the temperature of the at least one second battery of the battery charging sequence to provide a second battery temperature value; and ceasing charging of the at least one second battery in response to the second battery temperature value being outside a charging temperature range.

In accordance with the present invention, there is provided another method for efficient charging of a plurality of batteries. The method includes performing a charging loop that charges one or more of the plurality of batteries in a charging sequence order. The charging loop including at least determining a temperature of at least one nth battery of the plurality of batteries, determining a time limit for the at least on nth battery based on the temperature, the charging time is calculated to prevent any of the plurality of batteries from exceeding a maximum charging temperature, charging the at least one nth battery, monitoring a charging time over which the at least one nth battery is charging, ceasing charging of the at least one nth battery after the charging time equals or exceeds the time limit, and rotating to a next battery in the charging sequence order to repeat the charging loop with the next battery. The charging loop stops upon satisfaction of one or more completion conditions, the one or more completion conditions include one of a completion charge state of the plurality of batteries and removal of a charging power source.

Further in accordance with the present invention, there is provided a method for managing a charge rate of batteries. The method can comprise charging a plurality of batteries, monitoring a temperature of the plurality of batteries during charging, and derating at least one of the plurality of batteries based on the temperatures of the plurality of batteries. Derating the at least one of the plurality of batteries is effected using at least one equation defining at least one battery parameter.

These and other objects of this invention will be evident when viewed in light of the drawings, detailed description, and appended claims.

### BRIEF DESCRIPTION OF THE DRAWINGS

The above and/or other aspects of the invention will be more apparent by describing in detail exemplary embodiments of the invention with reference to the accompanying drawings, in which:

FIGS. 1A-1D are diagrams illustrating a hybrid welding device;

FIG. 2 illustrates staggered battery charging system;

FIG. 3 illustrates a methodology for charging batteries in a time-staggered fashion;

FIG. 4 illustrates a methodology for charging a plurality of batteries in view of a battery charging temperature range;

FIG. 5 illustrates a methodology for charging two batteries in a temperature-staggered fashion;

FIG. 6 illustrates a methodology for solving a charging sequence to charge a plurality of batteries in view of one or more temperatures in sectors of a battery bank;

FIG. 7 illustrates a methodology for conducting an interactive derate of battery charging in view of battery temperatures;

FIG. 8 illustrates a methodology for conducting an interactive derate of battery discharging in view of battery temperatures; and

FIG. 9 illustrates a methodology for managing an interactive derate of battery charging and discharging in view of sector temperatures in a battery bank.

### DETAILED DESCRIPTION

Embodiments of the invention will now be described below by reference to the attached figures. The described embodiments are intended to assist the understanding of the invention, and are not intended to limit the scope of the invention in any way. Like reference numerals refer to like elements throughout.

Many functions involving batteries cause heat. Both charging and discharging can result in the generation of heat. This heat can accumulate to cause the temperature of one or more batteries and nearby components to rise. However, batteries and some electronic components can be damaged or suffer from degraded performance at certain temperatures. Damage can reduce battery life or capacity, or in instances make the battery inoperable, while degraded performance can reduce charge or discharge efficiency or limit power or capacity temporarily.

In accordance with aspects herein, systems and methods can stagger at least the charging or recharging of batteries to limit the amount of heat generated and permit dissipation of heat to avoid damage or degraded performance. In some embodiments, a plurality of batteries in proximity or related in use (e.g., in a battery bank) can be analyzed as a group to determine charging sequences. In various embodiments, loading or discharge can also be managed using the same controllers and techniques.

While batteries herein may be referred to as “first,” “second,” “next,” “nth,” et cetera, it is understood that such terms are only employed to discriminate between individual batteries or groups of batteries, and do not necessarily control order or precedence in a charging sequence. It is convenient to describe batteries being charged in such manners, but it is understood that a “first” battery may potentially be in the middle of a sequence. Further, where specific numbers of batteries are described (e.g., first and second battery), it is understood such may only be relied upon for purposes of brevity, and the same components or techniques acting upon the defined number of batteries may be extended to any larger or smaller number of batteries. On the other hand, where a battery is identified as the “last” battery, this indicates the battery to be the final in a sequence, with none subsequent in at least a respective iteration.

As used herein, a charging sequence, battery charging sequence, and similar terminology refer to an order, matrix, plan, decision tree or graph, or intelligently resolved arrangement defining when batteries are charged (or not charged) in reference to one another and specific conditions (e.g., charge state, temperature).

Charging sequences can be performed in logical loops. The loops can include a plurality of aspects performed with or on a plurality of elements, repeated a number of times. Loop elements can include the plurality of batteries in one or more banks on which the loops are acting. There are nested loops described herein. A higher level loop can include, for example, repetition of an entire charging sequence or multiple charging sequences (e.g., perform charging technique on 10 batteries in sequence). A lower level or nested loop within the higher level loop can include, for example, all aspects performed with respect to an individual element among the plurality of elements of the sequence (e.g., individual steps taken with respect to each of 10 batteries in sequence). Thus, a lower level, nested loop may recycle or repeat multiple times with respect to different aspects before a higher level loop recycles.

Loops can have completion criteria to indicate either a time to recycle or to end the loop. For example, a sequence loop can have a sequence completion criteria, whereby the sequence restarts (or is solved again and proceeds in a different order) upon conditions. The sequence completion criteria can include, for example, the last element of the current sequence completing its charge or exceeding a temperature range. Thereafter, the sequence recycles.

A completion condition for all iterations (e.g., no more iterations of sequence or lower level loops therein) of the sequences can be a condition that ceases all charges an repetitions of one or more sequences, including one or more batteries being fully charged, one or more batteries being outside of a charging temperature range, one or more batteries being damaged and un-chargeable, loss of charging power, et cetera.

Where sequences or loops are said to “recycle,” the sequence or loop is repeated. Sequences or loops can be repeated in the same or different orders or arrangements.

Batteries can have various states. Charge states, states of health, and other states are described below. A completion charge state can be a level of charge that is acceptable to cease charging. In some embodiments, a completion charge state is a substantially full charge. In other embodiments, the completion charge state can be a different amount of charge. An overheat state can be a state whereby one or more batteries are above a charging temperature range. In some embodiments, an overheat state can be where multiple or all batteries in the sequence are above a charging temperature range.

As suggested, various criteria can depend on temperature. A battery can have a temperature value, which can be a point measurement, plurality of point measurements, temperature gradient, temperature average, surface temperature, core temperature, or other values related to heat effects on a battery or associated components. A charging temperature range can be defined which is a range (e.g., bounded by minima and/or maxima absolutely or based on other conditions) of temperatures in which a battery will exhibit desired characteristics when charging (e.g., level of efficiency, state of health effects prolonging battery life).

Aspects discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit or scope of the discussed inventions. The embodiments and discussions herein can be incorporated into any such systems and methodologies by those of skill in the art on review of the disclosures. Devices or components associated with welding operations, including batteries used in such operations, are referred to herein as “welding components.”

Additional aspects relate to managing the rates at which batteries are charged or discharged, and particularly relate to derating welding batteries to avoid creation of excessive heat or prolong their lifespan.

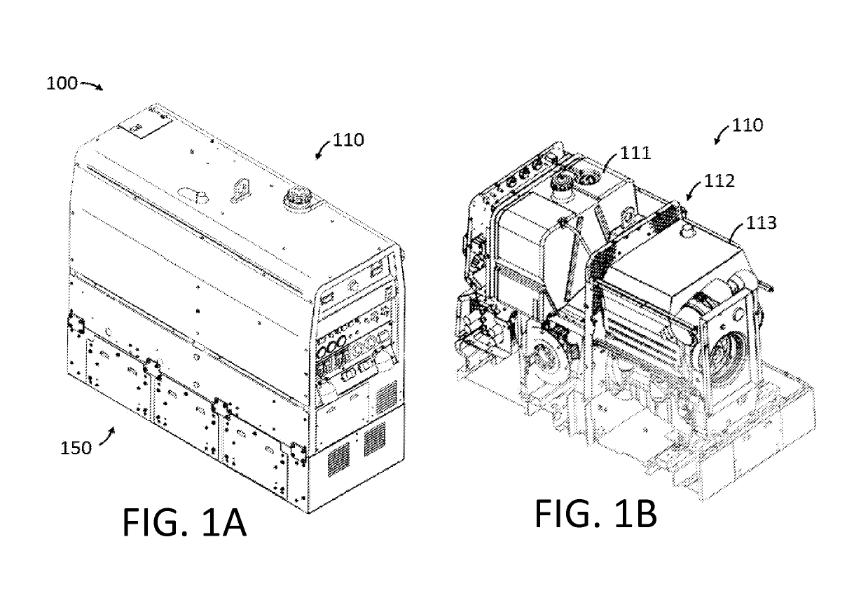

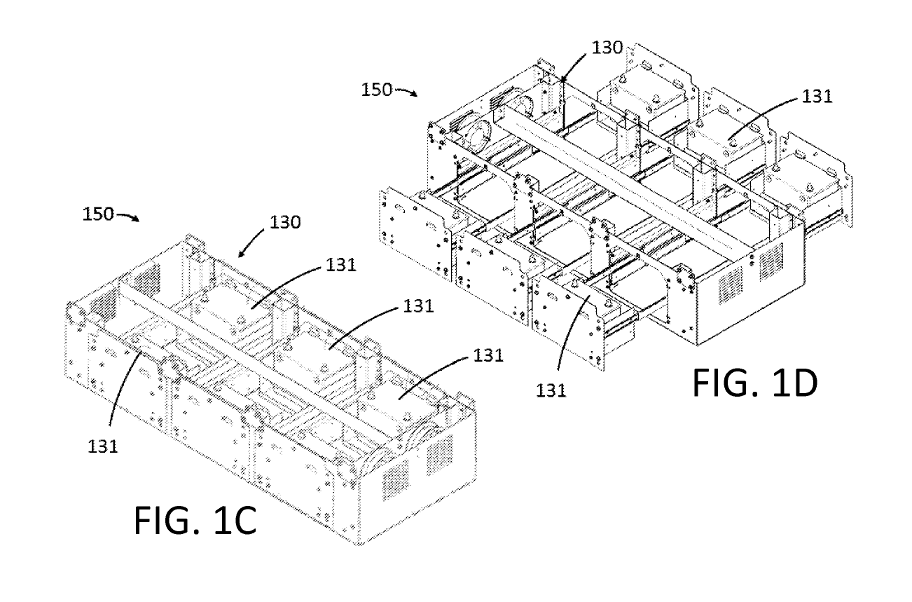

FIGS. 1A-1D illustrate a hybrid welding device (herein referred to as a “hybrid welder”). A hybrid welder according to the invention is generally indicated by the number 100 in the drawings. Hybrid welder 100 includes an engine component that runs on fuel from fuel storage 111 allowing the hybrid welder 100 to be portable. It will be appreciated that hybrid welder 100 may also be mounted in a permanent location depending on the application. Hybrid welder 100 generally includes a motor-driven welder assembly 112 having a motor 113 and an energy storage device 150. Motor 113 may be an internal combustion engine operating on any known fuel including but not limited to gasoline, diesel, ethanol, natural gas, hydrogen, and the like. These examples are not limiting as other motors or fuels may be used.

The motor 113 and energy storage device 150 may be operated individually or in tandem to provide electricity for the welding operation and any auxiliary operations performed by hybrid welder 100. For example, individual operation may include operating the motor 113 and supplementing the power from the motor 113 with power from the energy storage device 150 on an as needed basis, or supplying power from the energy storage device 150 alone when the motor 113 is offline. Tandem operation may also include combining power from motor 113 and energy storage device 150 to obtain a desired power output. According to one aspect of the invention, a welder 100 may be provided with a motor having less power output than ordinarily needed, and energy storage device 150 used to supplement the power output to raise it to the desired power output level. In an embodiment, a motor with no more than 19 kW (25 hp) output may be selected and supplemented with six 12 volt batteries. Other combinations of motor output may be used and supplemented with more or less power from energy storage device. The above example, therefore, is not limiting.

Energy storage device 150 may be any alternative power source including a secondary generator, kinetic energy recovery system, or, as shown, one or more batteries 131. Batteries 131 can be maintained in a battery bank 130 that electrically integrates batteries 131. Batteries 131 can be accessed in battery bank 130 using various movable members. In an embodiment, six 12 volt batteries 131 are wired in series to provide power in connection with motor-driven welder assembly 112. Batteries 131 shown are lead acid batteries. Other types of batteries may be used including but not limited to NiCd, molten salt, NiZn, NiMH, Li-ion, gel, dry cell, absorbed glass mat, and the like.

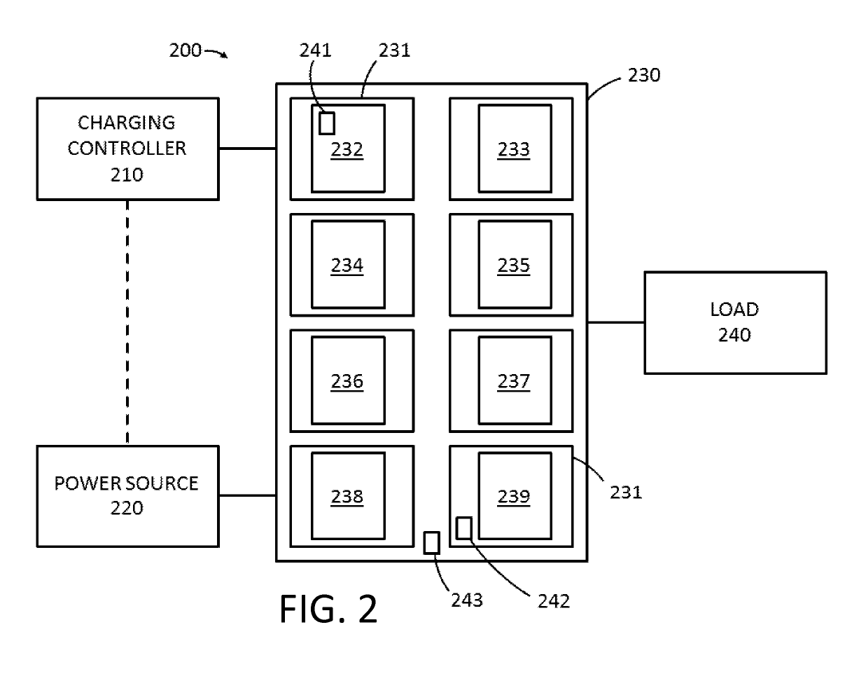

Modes for carrying out the invention will now be described for the purposes of illustrating embodiments known to the applicant at the time of the filing of this patent application. The examples and figures are illustrative only and not meant to limit the invention, which is measured by the scope and spirit of the claims. Referring now to the drawings, wherein the showings are for the purpose of illustrating an exemplary embodiment of the invention only and not for the purpose of limiting same, FIGS. 2-8 illustrate at least aspects discussed in FIGS. 1A-1D in schematic block diagram form.

FIG. 2 illustrates staggered battery charging system 200. Staggered battery charging system 200 includes charging controller 210 operatively coupled to battery bank 230, and, in some embodiments, operatively coupled with power source 220. Power source 220 provides power to at least charge or recharge batteries 232-239, and, in some embodiments, can provide direct power to other components (e.g., power a computer associated with charging controller 210, provide direct power to load 240).

Charging controller 210 functions to control when batteries 232-239 in battery bank 230 are charged based on local temperatures within battery bank 230 and the charge state of one or more batteries 232-239 which are coupled in battery bank 230 using battery cradles 231. In some embodiments, the demand of load 240 and/or an anticipated change in load 240 can also be utilized by charging controller 210.

Charging controller 210 receives information from one or more sensors related to battery bank 230. Sensors can include battery information gauge 241, cradle information gauge 242, and bank information gauge 243. Battery information gauge 241, cradle information gauge 242, and bank information gauge 243 provide at least information relevant to charging cycles, and particularly, to coordinating charging cycles to optimize charging according to temperature and/or other variables. Battery information gauge 241, cradle information gauge 242, and bank information gauge 243 can include one or more of thermometers, state-of-charge (or depth-of-discharge) gauges (e.g., voltmeter, hydrometer, chemical tester, current integrator, pressure gauge or switch, gaussmeter or magnetic field meter, model or filter), load testers, state of health gauges (e.g., internal resistance gauge, capacity gauge or ratio, voltage calculation, self-discharge effects, charge acceptance, charge-discharge cycle counter, parameter weighting), and others. In some embodiments, one or more of battery information gauge 241, cradle information gauge 242, and bank information gauge 243 can be a battery management system (BMS). In alternative embodiments, charging controller 210 can function as a BMS. In still alternative embodiments, a plurality of components can operate as a BMS.

While battery information gauge 241, cradle information gauge 242, and bank information gauge 243 are shown as single discrete components, it is understood that the functions of such components can be distributed through the system, and that a plurality of sensors at a plurality of locations can be used to effect battery information gauge 241, cradle information gauge 242, and bank information gauge 243. For example, a plurality of thermometers can be employed throughout battery bank 230, including but not limited to being integrated in battery cradles 231 and batteries 232-239, to provide not only a point temperature but a map of temperatures throughout battery bank 230 and associated components. In some embodiments, thermometers can be placed at known locations (e.g., location detected, location programmed) and temperature information can be mapped according to the temperatures and locations. In alternative embodiments, the locations of various sensors are not known, but temperature statistics can be gathered irrelevant of location. In still other embodiments, sensors are not associated with an absolute location, but rather with one or more batteries 232-239 and/or proximate areas. Additionally, it is not necessary that the sensors depicted in particular components exist in those elements, and they may exist in elements where not illustrated.

Based on one or more of temperatures, charge and discharge amounts, usage or load, and external power (e.g., power source 220) availability with respect to one or more batteries 232-239, charging controller 210 selectively charges one or more batteries 232-239 among battery bank 230 according to a timeline or sequence. The timeline or sequence can be calculated in advance of execution or developed continuously in view of actual conditions relating to staggered battery charging system 200. In some embodiments, a combination of both techniques can be utilized (e.g., a charging sequence solved before beginning the charging sequence can be adjusted in view of local temperatures within battery bank 230 before completion of the originally solved charging sequence).

In an example of one or more embodiments, batteries 232-239 are recharged in view of local temperatures within battery bank 230. For example, battery bank 230 can be attached to load 240, which begins to drain batteries 232-239. After completion of an operation associated with load 240, batteries 232-239 are drained (e.g., low state of charge, high depth of discharge) requiring recharging. In this example, each battery 232 in battery bank 230 is the same battery, and each battery 232 is at a substantially similar state of health and state of charge. Thus, in isolation, each battery should require the same charging to return to a same recharged state of charge.

In order to effect recharging, charging controller can send a charge signal to one or more components of staggered battery charging system 200. The charge signal can be a signal to initiate charging. At other times, a charge signal can be a signal to modify charging (e.g., change rate, change source). At still other times, a charge signal can be a signal to cease charging at least one battery. The charging signal can be executed via hardware (e.g., mechanical controller closes or completes circuit), software (e.g., portion of code executed), or a combination thereof. The charging signal can affect one or more of power source 220, batteries 232-239, battery cradles 231, battery bank 230, or other components to manage charging of batteries 232-239. In specific embodiments, the charging signal can prompt power source 220, directly or via battery bank 230 (or components thereof or attached thereto), to begin providing power to charge one or more of batteries 232-239. In alternative or complementary embodiments, the charging signal can cause one or more of battery bank 230, battery cradles 231, or batteries 232-239 to begin drawing power. In some embodiments there can be a plurality of charging signals to coordinate staggered charging among batteries using one or more power supplies including power source 220.

Returning to the example, at the time of charging, the batteries may already be at an elevated temperature due to use (discharging), and charging the batteries causes additional heat to be generated. To avoid degraded performance from elevated temperatures, a recharging sequence can be managed using charging controller 210 based on detected temperatures at one or more locations in or around battery bank 230. One or more batteries 232-239 can be recharged at a time, and as the batteries 232-239 are recharged, their temperature can change. These temperature changes can be monitored and/or modeled to determine if or when one or more of batteries 232-239 should cease charging and another should begin charging.

Because the temperature of one of batteries 232-239 is influenced by neighboring components (e.g., heat from battery 232 increases the ambient temperature around battery 234), it may be most efficient to stagger charging of batteries 232-239 through a sequence where simultaneous charging of two or more batteries 232-239 is done using batteries that are non-neighboring among batteries 232-239. In the current example, battery 232 and 237 can be charged simultaneously. After a temperature threshold is reached at one or both of batteries 232 and 237, the charging can be staggered such that charging of batteries 232 and 237 ceases, and charging of batteries 234 and 239 begins. Thereafter, charging can shift to batteries 236 and 233, and one cycle of the sequence can end with charging batteries 238 and 235. The cycle can repeat as-needed until one or more cease bank charging conditions are met. For example, cease bank charging conditions batteries 232-239 are fully charged, have achieved a desired state of charge, are all above or near a maximum charging temperature, are needed for other operations, no longer have access to power source 220, or other conditions.

The above example provided merely one example of a charging sequence, and does not describe every possible such sequence. It will be understood on review of the disclosures herein that charging sequences will be dependent upon the rates of heat generation and dissipation (or other variables) particular to staggered battery charging system 200, and can be managed by time (e.g., each battery charges for 20 minutes), condition or status (e.g., each battery charges until reaching 400° Celsius), or combinations thereof.

In other examples, all batteries can be recharged at once, and selectively cease charging individually as needed to prevent overheating. In still other examples, batteries can be charged one at a time, three at a time, or in any other number. Batteries can be treated differently based on differential states of charge or states of health. In some embodiments, middle batteries may absorb more heat or dissipate slower due to being surrounded on two or more sides by other batteries (e.g., higher ambient temperature, less ventilation), and may accordingly be staggered in a different fashion than corner or exterior batteries.

In addition to point temperature measurements, temperature gradients, maps, or models may be employed. Further, one or more qualities or quantities of batteries 232-239 are represented by formulae or equations relating performance and other parameters to environmental variables, use history, and other values. Calculations can be performed to define and/or refine one or more charging sequences using these and other operations.

Various other constraints or conditions can change the nature of calculations or estimations herein. For example, simultaneous charge and discharge may modify rates at which heat is generated. Alternatively, charging or heat from the same may modify the discharge characteristics of one or more batteries 232-239, necessitating specific staggering or charging plans to provide the required power. Further, charging sequences can be developed around specific times when connected to a source or load (e.g., engine generator recharging can only run for 2-hours, known or unknown load will be connected in 30 minutes), around quantities associated with a charge or load (e.g., maximum or minimum voltages or currents), and others.

In addition, various ranges, maxima, or minima may be variable or dependent on other variables. For example, a battery may have a maximum temperature of 450° Celsius for 15 minutes, and thereafter a maximum temperature of 400° Celsius.

These techniques and analyses can be utilized alone or in combination with one another.

Staggering sequences can also include calculations related to a length of time required to reach a particular state. For example, a battery can continue to rise in temperature at least briefly after ceasing charge or discharge, and may require substantial lengths of time to dissipate heat after its temperature is increased. Accordingly, charging controller 210 or other components can compensate for transition times or other delays in effecting particular states to staggered battery charging system 200.

Further, while staggered battery charging system 200 is shown with charging controller 210 connected to a single battery bank 230, it is understood that a plurality of controllers including charging controller 210 can interact, and/or multiple banks including battery bank 230 can be managed with one or more controllers including charging controller 210.

These and other techniques used in sequencing, scheduling, or optimization can be effected at least in part based on a dynamic model associated with one or more banks including battery bank 230. Charging controller 210 can include or be operatively linked to a storage memory that maintains information related to at least staggered battery charging system 200 in a database. The database may be leveraged by charging controller 210 or other components (local or remote) to model the state(s) of one or more of batteries 232-239, battery cradles 231, and/or battery bank 230 and more accurately predict and manage future states under a given set of conditions. In some embodiments, such models enable charging controller 210 can develop and execute flexible, accurate charging sequences staggering charging among at least batteries 232-239 to, for example, limit the build-up of heat and encourage its dissipation in staggered battery charging system 200.

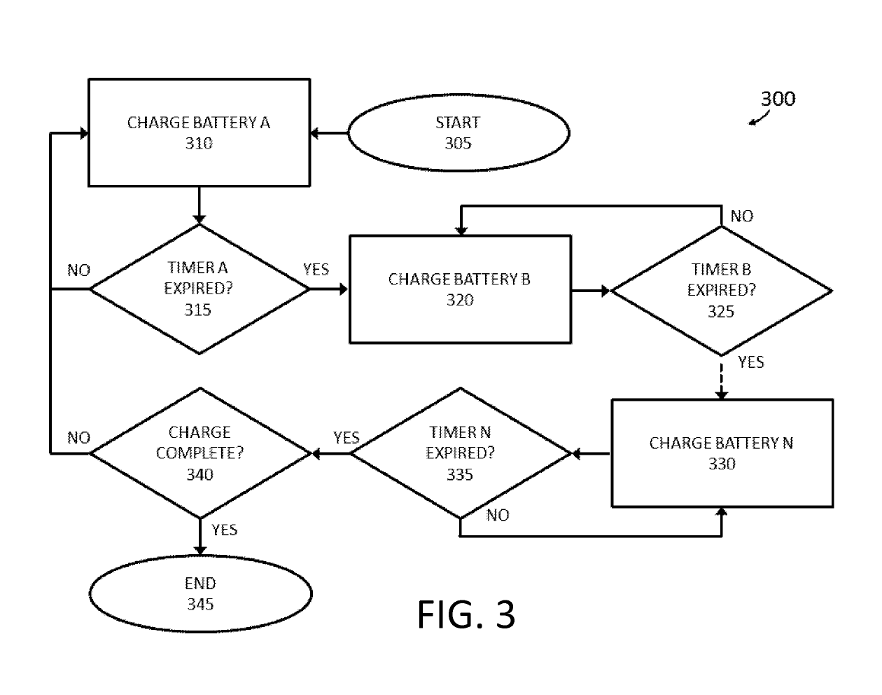

FIG. 3 illustrates a methodology 300 for charging n batteries in a time-staggered fashion. At 305, methodology 300 begins and proceeds to 310 where a first battery A is charged. At 315, a determination is made as to whether a charging time associated with first battery A is completed. If the time has not lapsed, charging of first battery A continues at 310.

If the charge time associated with first battery A is complete, methodology 300 proceeds to 320 where charging of second battery B begins. At 325, a determination is made as to whether a charging time associated with second battery B is completed. If the time has not lapsed, charging of second battery B continues at 320.

If the charge time associated with second battery B is complete, methodology 300 proceeds to 330 where charging of nth battery N begins. At 335, a determination is made as to whether a charging time associated with nth battery N is completed. If the time has not lapsed, charging of nth battery N continues at 330.

This timed charging sequence can continue until all batteries have been charged according to respective associated charging times. After all batteries in the cycle's sequence have charged for the appropriate times, methodology 300 can proceed to 340 where a determination is made as to whether charging is complete. If additional charging cycles of methodology 300 are required, methodology 300 recycles to 310 where first battery A is charged again. In some embodiments, methodology 300 may recycle to a different point to begin with a different battery, proceed through charging in a different order, or skip some batteries altogether (e.g., due to residual temperature, state of health, state of charge, or other variables associated with the battery). If charging on all batteries A-N is complete, methodology may proceed to 345 where methodology 300 ends.

Those of skill in the art will understand that, while batteries are referred to in methodology 300 and elsewhere in the singular, each such reference can identify two or more batteries in some embodiments, and that such groups may be variable depending upon conditions. Further, time associated with timers at, e.g., 315, 325, and 335 can be the same lengths of time or different lengths of time, and lengths of time may vary through subsequent iterations of methodology 300.

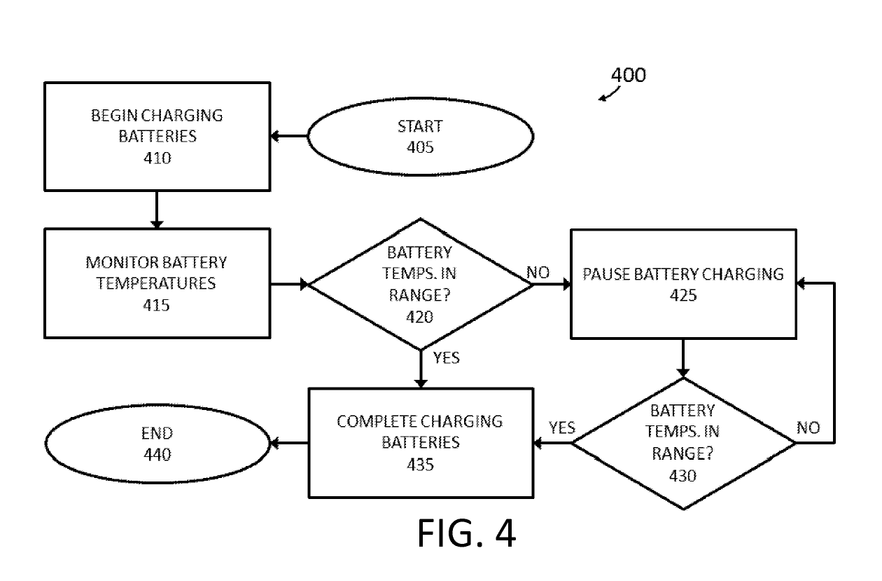

Turning now to FIG. 4, illustrated is a methodology 400 for charging a plurality of batteries in view of a battery charging temperature range. Methodology 400 begins at 405 and proceeds to begin charging batteries at 410. The batteries being charged at 410 can include one or more of a plurality of batteries (e.g., in a bank, in associated banks, associated with a particular operation or group of devices). In some embodiments, the batteries are to be charged according to a predetermined sequence, and are staggered to avoid excessive development of high temperatures in batteries or specific locations around batteries. Excessive development of high temperatures can include (but is not limited to) battery or ambient temperatures which degrade battery performance (e.g., charging time, charging capacity, battery life, output).

Battery temperatures of at least the charging batteries are monitored at 415 to provide feedback regarding the impact of charging on the battery temperatures. Temperature monitoring can be performed at discrete intervals (e.g., temperature evaluated every two-minutes), on a continuous or real-time basis (e.g., constant monitoring for temperature change, temperature change evaluated as-detected), or according to combination or alternative timing. In some embodiments, batteries not being charged are also monitored (e.g., due to heat conducted from adjacent batteries, rising ambient temperatures, heat generated from discharge).

At 420, a determination is made as to whether the temperatures of one or more batteries are within a charging temperature range. If the battery or batteries being charged are within the charging temperature range at 420, methodology 400 advances to 435.

If one or more batteries are found to exceed the charging temperature range, methodology 400 can proceed to 425 where the charging of at least the batteries above the charging temperature range is paused or ceased (e.g., until the temperature is reduced, until the sequence proceeds to return to the batteries, until a subsequent recharge).

At 425, some embodiments can execute additional steps to maintain or restore acceptable temperatures in a plurality of batteries being charged according to a staggered technique. For example, a cooling system can be activated to more quickly cool the battery or batteries that have (at least temporarily) ceased charging. A rotation criteria can be met according to measured temperatures, and one or more sequences can proceed or be modified in view of the determination at 420 and subsequent action at 425.

In some embodiments, temperature ranges can be determined to account for safety factors or imperfections within a system. For example, if degraded performance or damage occurs at 175° Celsius, the maximum of the charging temperature range can be set at 150° to prevent undesired outcomes. This can also facilitate faster return to a state at which charging (or other heat-generating activity) can resume, or permit a buffer in the event that heat continues to build after the maximum of the threshold is hit (e.g., adjacent batteries still charging raise temperature).

At 430, a determination can be made as to whether the monitored battery temperatures are within the charging temperature range. If this determination returns negative, methodology 400 returns to 425 where the heat can be conducted away or dissipate until the temperatures return to the charging range.

Once the determination at 430 returns positive (or if the determination at 420 returned positive), methodology 400 advances to 435 where the charging process is completed. Upon completion of the charging process, methodology 400 proceeds to end at 440. In alternative embodiments, methodology 400 can cycle through an additional iteration, continue through a sequence, or perform other actions after 435.

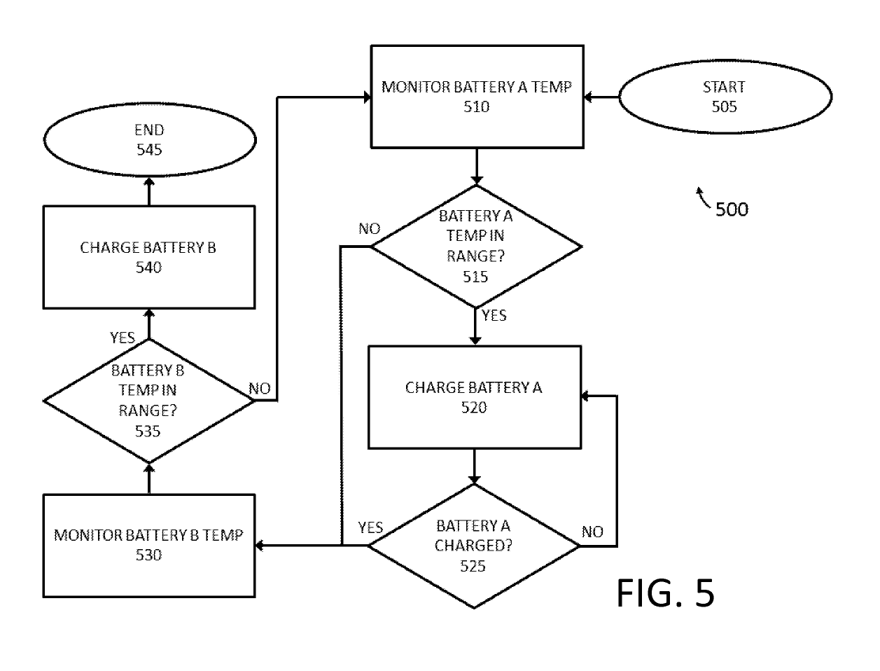

FIG. 5 illustrates a methodology 500 for charging two batteries in a temperature-staggered fashion. Methodology 500 begins at 505 and proceeds to 510 where the temperature of a first battery A is monitored. While or after determining temperature values of first battery A, a determination is made at 515 as to whether the temperature of first battery A is within a determined temperature range. If it is determined that the temperature of first battery A is within the determined temperature range, methodology 500 proceeds to charge first battery A at 520.

At 525, a determination is made as to whether first battery A is charged (e.g., to a full amount, to a predetermined amount, to an amount possible to charge to while remaining within a temperature range). If this determination is returned negative, methodology 500 returns to 520 where charging continues.

If the determination at 515 returns negative, or if the determination at 525 returns positive, methodology 500 advances to 530 where a temperature of a second battery B is monitored. While or after determining temperature values of second battery B, a determination is made at 535 as to whether the temperature of second battery B is within a determined temperature range. If it is determined that the temperature of second battery B is within the determined temperature range, methodology 500 proceeds to charge second battery B at 540. Thereafter, methodology 500 can proceed to end at 545.

While methodology 500 is shown as ending after charging second battery B, it is understood that various other loops and steps (e.g., checking whether second battery B is fully charged) can be included in this and other methodologies without departing from the scope or spirit of the innovation.

Further, as with other systems and methodologies herein, it is understood that more or fewer batteries, sequences, iterations, et cetera, can be applied or acted upon (e.g., additional steps for third battery C, fourth battery D, nonlinear sequence between batteries) using the techniques disclosed.

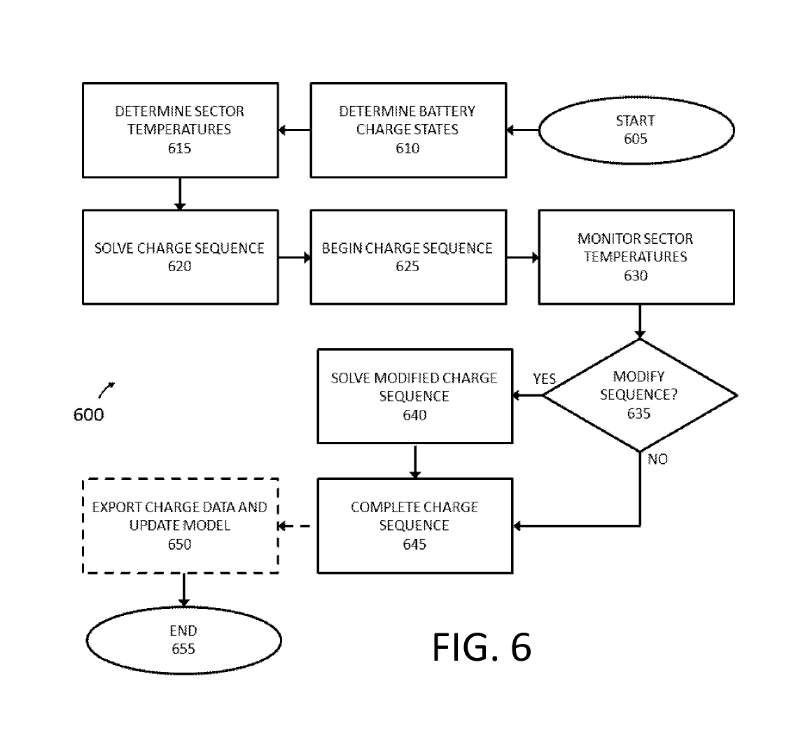

Turning now to FIG. 6, illustrated is a methodology 600 for solving a charging sequence to charge a plurality of batteries in view of one or more temperatures in sectors of a battery bank. Methodology 600 begins at 605 and proceeds to 610 where battery charge states are determined. Charge states can include a state of charge, a depth of discharge, a state of health, or other information related to a battery's current energy storage and maximum capacity.

At 615, sector temperatures are determined. Sectors can include individual batteries, or multiple temperature measurements from within those batteries (e.g., temperatures at one or more cells, core temperature versus external temperature, temperatures at top and bottom). Sector temperatures can also include groups of batteries, one or more battery banks, areas within battery banks, and others. Sector temperatures can be related based on proximity to other sectors, and, in some embodiments, models can be developed or provided which determine the effects of heat from one sector on the temperature of another sector.

At 620, a charge sequence is solved based on at least the battery charge states and sector temperatures. Specifically, using information about the batteries, battery bank(s), charge states, and sector temperatures, a charge sequence can be produced which charges the batteries in a staggered sequence in view of optimum temperature ranges. Optimum temperature ranges can facilitate charging efficiency or stability, discharge efficiency or availability, damage prevention, battery life, or other ends.

After solving the charge sequence at 620, execution of the charge sequence can begin at 625. While the charging sequence is underway, sector temperatures can be monitored at 630.

Depending on the feedback provided, a determination can be made at 635 as to whether the sequence should be modified. The determination at 635 may return positive if, for example, one or more sector temperatures exceeds a maximum temperature for that sector or the system, the charging sequence is deviating from the expected results (e.g., faster charging than expected, slower charging than expected, less heat generated than expected from model), or other conditions occur.

If the determination at 635 returns positive, a modified charge sequence can be solved at 640. The modified charge sequence can adjust or replace the original charge sequence developed at 620 to, for example, keep methodology 600 from departing from method parameters (e.g., exceed maximum sector temperature), expedite completion of charging, ensure the availability of one or more batteries to a welding operation, maximize charge before a power source becomes unavailable, or accomplish other ends. A modified charging sequence can, for example, change the order in which one or more batteries is charged, change the time for which one or more batteries is charged, add or remove batteries from a charging sequence, change the electrical parameters (e.g., current, voltage) at which one or more batteries is charged, or effect other modifications.

If the determination at 635 returns negative, or after solving a modified charge sequence at 640, methodology 600 proceeds to 645 where the charging sequence is completed. In some embodiments, additional iterations of methodology 600 can be completed (e.g., multiple evaluations as to whether to modify a charging sequence, multiple modified charging sequences solved and run).

After completing the charging sequence, methodology 600 proceeds to end at 655.

In some embodiments, methodology 600 can perform an additional step at 650 where information regarding the actual performance of one or more charge sequences executed during methodology 600 is exported to a database for analysis. For example, information regarding charge time, battery health, charging power supply, load, external factors (e.g., air temperature, humidity, time of day, sunlight), et cetera, can be included in a database. Using various statistical calculations and/or updated information regarding the equipment (e.g., more accurate equations describing charge or discharge curves for the specific battery), one or more models used to solve a charging sequence can be updated to improve the quality of a solved charging sequence or provide additional conditions or variables which can be utilized or factored in calculation.

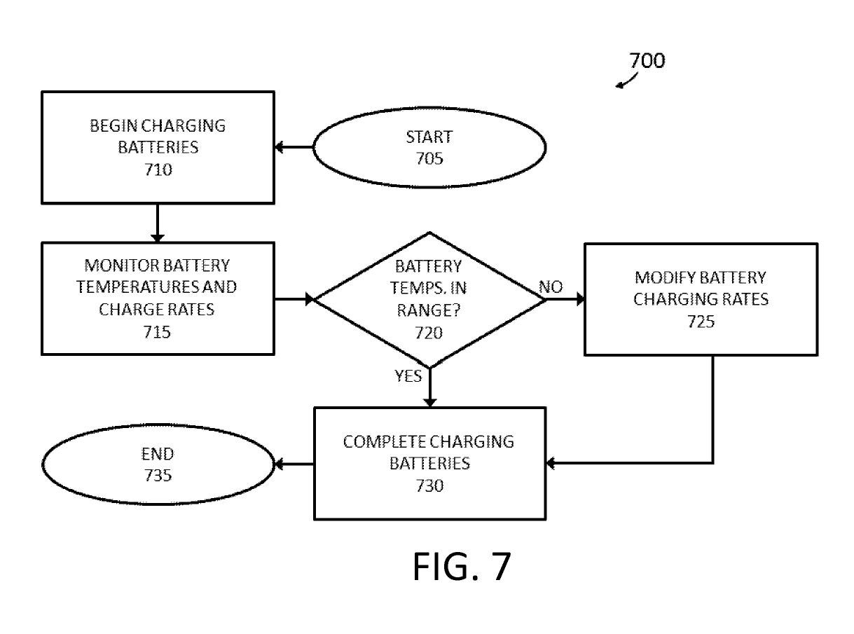

FIG. 7 illustrates a methodology 700 for conducting an interactive derate of battery charging in view of battery temperatures. An interactive derate can be performed using various control systems, including a charging controller, BMS, computer, mechanical switch, or other logic or mechanism. Methodology 700 begins at 705 and proceeds to 710 where battery charging begins.

At 715, the temperatures and charge rates of the batteries are monitored. In some embodiments, a charge rate can be known, and thus only temperature is monitored. Charge rate can be measured according to a number of metrics, including (but not limited to) a current or voltage from a charging power supply, a change in percent of full theoretical charge (e.g., perfect battery at maximum state of health), change in percent of full calculated or actual charge (e.g., existing battery at calculated or known state of health), and others.

At 720, a determination is made as to whether the temperature of one or more batteries being charged is within a charging range. The charging range can be, for example, a range of temperatures at which the battery charges effectively (e.g., no degraded performance or damage due to high or low temperature). If the determination at 720 returns negative, methodology 700 can proceed to 725 where charging rates are modified. For example, a battery undergoing charging can be derated whereby the charging rate is reduced to diminish heat generation and control the temperature of a battery undergoing charge. Alternatively, a charging rate could be increased to raise a battery's temperature (e.g., during outdoor use in cold weather).

If the determination at 720 returns positive, or after modifying battery charging rates at 725, charging of the batteries can be completed at 730. Thereafter, methodology 700 can end at 735.

It is understood that methodology 700 need not be confined to a single battery, and can be applied simultaneously or sequentially to two or more batteries. For example, two batteries in the same bank may change in temperatures at different rates (e.g., due to location, other batteries in proximity), and accordingly, their charging rates can be modified to maintain both at substantially equal temperatures.

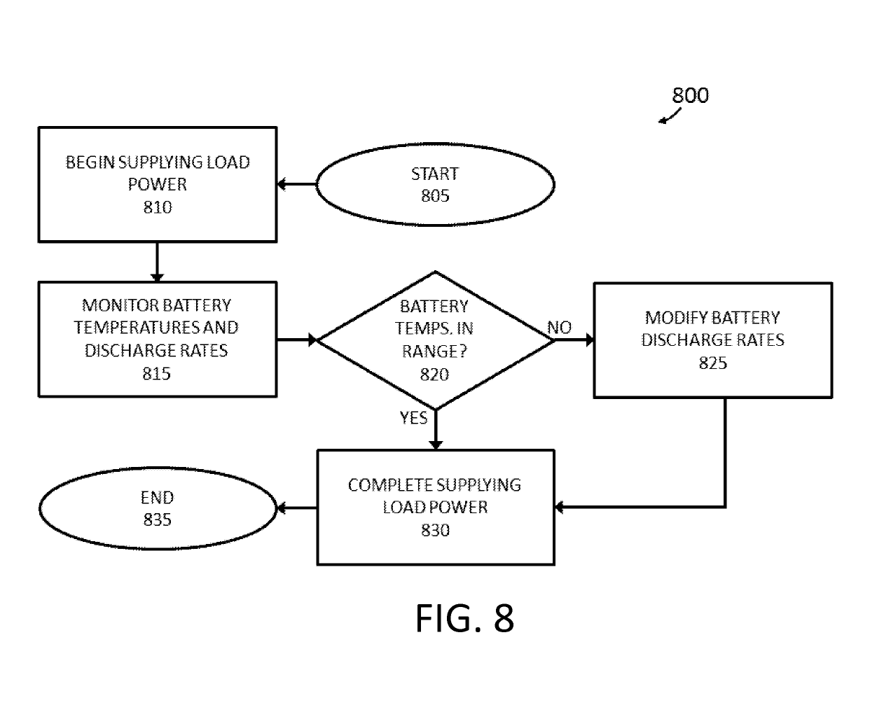

FIG. 8 illustrates a methodology 800 for conducting an interactive derate of battery discharging in view of battery temperatures. Methodology 800 begins at 805 and advances to 810 where battery discharging begins by way of supplying power to a load at a first rate.

At 815, the temperatures and discharge rates of the batteries are monitored. In some embodiments, a discharge rate can be known, and thus only temperature is monitored. Discharge rate can be measured according to a number of metrics, including (but not limited to) a current or voltage from the battery to the load, a change in percent of full theoretical charge (e.g., perfect battery at maximum state of health), change in percent of full calculated or actual charge (e.g., existing battery at calculated or known state of health), and others.

At 820, a determination is made as to whether the temperature of one or more batteries being discharged is within a discharging range. The discharging range can be, for example, a range of temperatures at which the battery supplies power to the load effectively (e.g., no degraded performance or damage due to high or low temperature). If the determination at 820 returns negative, methodology 800 proceeds to 825 where discharging rates are modified. For example, a battery supplying power to a load can be derated whereby the discharge rate is reduced to diminish heat generation and control the temperature of a battery undergoing discharge. In some embodiments, a discharge range can be provided that ensures adequate power is provided to support the load while still permitting adjustments to the discharge rate. Alternatively, a discharging rate could be increased to raise a battery's temperature (e.g., during outdoor use in cold weather).

If the determination at 820 returns positive, or after modifying battery discharging rates at 825, discharge of the batteries can be completed at 830. The batteries need not be completely discharged, but merely disconnected from or cease supplying to the load. Thereafter, methodology 800 can end at 835.

It is understood that methodology 700 need not be confined to a single battery, and can be applied simultaneously or sequentially to two or more batteries. For example, two batteries in the same bank may change in temperatures at different rates (e.g., due to location, other batteries in proximity), and accordingly, their discharging rates can be modified to maintain both at substantially equal temperatures.

Further, to support an operation associated with a load, multiple batteries may have their discharge rates increased or decreased to ensure adequate power is supplied to the load while facilitating management of temperature or other parameters relating to the batteries.

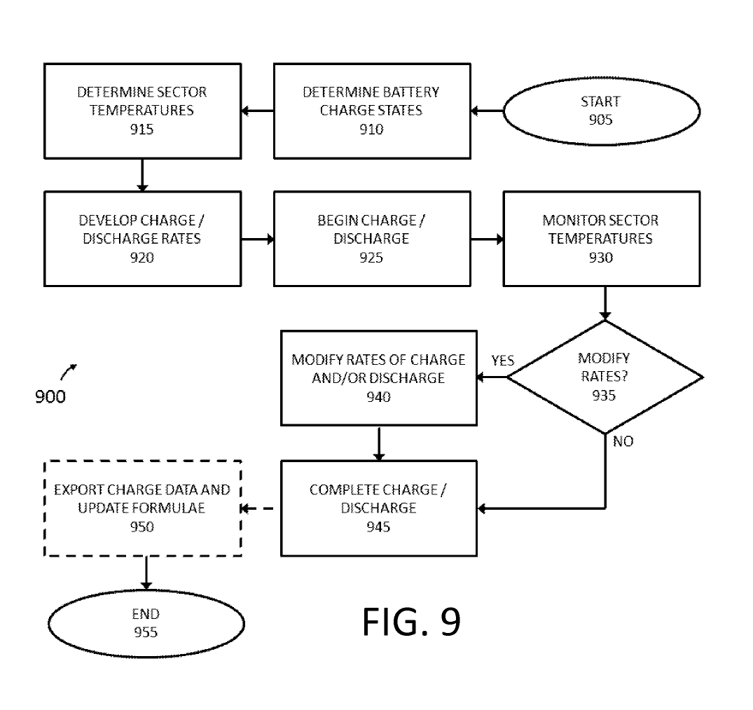

FIG. 9 illustrates a methodology 900 for managing an interactive derate of battery charging and discharging in view of sector temperatures in a battery bank. Methodology 900 begins at 905 and advances to 910 where battery charge states are determined. At 915, sector temperatures for the one or more batteries and/or associated battery banks are determined.

Upon completing an evaluation of a current state, at 920 a model can be completed setting describing charge and discharge rates for one or more batteries that will allow the batteries to be charged and/or supply power to a load within parameters such as temperature constraints.

After the rates of charge or discharge have been solved, charge or discharge of one or more batteries can begin at 925. At 930, sector temperatures are monitored to provide feedback regarding the charge and discharge rates and their impact on sector temperature.

At 935, a determination is made regarding whether to modify the charge or discharge rates based at least in part on the monitored temperature. If resultant temperatures are too high or low, methodology 900 advances to 940 where the rates of charge or discharge can be modified (e.g., derated) to optimize the temperature or other variables (e.g., other variables influencing battery life).

Methodology 900 proceeds to 945 after 940 or if the determination at 935 returns in the negative. At 945, the charge or discharge operation can be completed, and methodology 900 can end at 955.

In some embodiments, methodology 900 can perform an additional step at 950 where information regarding the actual performance of one or more charge/discharge operations executed during methodology 900 is exported to a database for analysis. For example, information regarding charge time or rate, discharge time or rate, battery health, charging power supply, load(s), external factors (e.g., air temperature, humidity, time of day, sunlight), et cetera, can be included in a database. Using various statistical calculations and/or updated information regarding the equipment (e.g., more accurate equations describing charge or discharge curves for the specific battery), one or more models used to calculate charge or discharge rates can be updated to improve the quality of derating processes or provide additional conditions or variables which can be utilized or factored in calculation.

While methodologies 300-900 show particular embodiments of methodologies herein, one of ordinary skill in the art will appreciate that various methodologies or steps thereof can repeat, be conducted in a different order, and so forth. Steps can occur concurrently, such as during continuous temperature monitoring or where control is based on other feedback.

While embodiments discussed herein have been related to the systems and methods discussed above, these embodiments are intended to be exemplary and are not intended to limit the applicability of these embodiments to only those discussions set forth herein. The control systems and methodologies discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit of scope of the above discussed inventions. The embodiments and discussions herein can be readily incorporated into any of these systems and methodologies by those of skill in the art. By way of example and not limitation, a power supply as used herein (e.g., welding power supply, among others) can be a power supply for a device that performs welding, arc welding, laser welding, brazing, soldering, plasma cutting, waterjet cutting, laser cutting, among others. Thus, one of sound engineering and judgment can choose power supplies other than a welding power supply departing from the intended scope of coverage of the embodiments of the subject invention. Other variations, related and unrelated to those briefly described above, will be understood by those of skill in the art upon review of the disclosures herein.

What is claimed is:

1. A method for controlling the charging of a plurality of batteries, the method comprising:
charging at least one first battery in a battery charging sequence;
monitoring a temperature of the at least one first battery of the battery charging sequence to provide a first battery temperature value;
ceasing charging of the at least one first battery in response to the first battery temperature value being outside a charging temperature range;
charging at least one second battery in a battery charging sequence in response to ceasing charging of the at least one first battery;
monitoring the temperature of the at least one second battery of the battery charging sequence to provide a second battery temperature value; and
ceasing charging of the at least one second battery in response to the second battery temperature value being outside a charging temperature range.

2. The method of claim 1, further comprising:
charging at least one next battery in a battery charging sequence in response to ceasing charging of the at least one first battery;
monitoring the temperature of the at least one next battery of the battery charging sequence to provide a next battery temperature value.

3. The method of claim 2, further comprising ceasing charging of the at least one next battery in response to the next battery temperature value being outside a charging temperature range.

4. The method of claim 2, further comprising:
determining the at least one next battery is a last element of the battery charging sequence;
determining a sequence completion criteria is complete;
determining the battery charging sequence recycles after completion;
determining the first battery temperature value is within the charging temperature range; and
restarting the battery charging sequence by charging the at least one first battery in the battery charging sequence.

5. The method of claim 1, further comprising identifying battery charge states for the plurality of batteries.

6. The method of claim 5, further comprising solving the battery charging sequence based at least in part on the battery charge states.

7. The method of claim 6, wherein the battery charging sequence is additionally based on the location of plurality of batteries with respect to one another.

8. The method of claim 6, wherein the battery charging sequence is additionally based on a geometry of a battery bank enclosing at least a portion of the plurality of batteries.

9. The method of claim 6, wherein the battery charging sequence is additionally based on a parameter of a charging power source.

10. The method of claim 1, wherein the battery charging sequence is modified based at least in part on one of the first battery temperature value and the second battery temperature value.

11. A method for efficient charging of a plurality of batteries, the method comprising:
performing a charging loop that charges one or more of the plurality of batteries in a charging sequence order, the charging loop including at least:
determining a temperature of at least one nth battery of the plurality of batteries;
determining a time limit for the at least one nth battery based on the temperature, the time limit is calculated to prevent any of the plurality of batteries from exceeding a maximum charging temperature;
charging the at least one nth battery;
monitoring a charging time over which the at least one nth battery is charging;
ceasing charging of the at least one nth battery after the charging time equals or exceeds the time limit; and
rotating to a next battery in the charging sequence order to repeat the charging loop with the next battery;
wherein the charging loop stops upon satisfaction of one or more completion conditions, the one or more completion conditions include one of a completion charge state of the plurality of batteries and removal of a charging power source.

12. The method of claim 11, further comprising modifying the charging sequence order based on a charge state of the at least one nth battery.

13. The method of claim 11, further comprising monitoring continuously the temperature of the at least one nth battery.

14. The method of claim 13, further comprising modifying the charging sequence order based on the temperature of the at least one nth battery.

15. The method of claim 13, wherein the one or more completion conditions additionally include an overheat state.

16. The method of claim 11, wherein the time limit is additionally based at least in part on an equation defining at least one battery parameter of the nth battery.

17. The method of claim 11, further comprising determining a charge state of the at least one nth battery.

18. The method of claim 11, further comprising solving the charging sequence order.

19. The method of claim 11, wherein the charging sequence order is based at least in part on one or more of an equation defining at least one battery parameter, a location of the plurality of batteries with respect to one another, and a geometry of a battery bank enclosing at least a portion of the plurality of batteries.

20. A method for managing a charge rate of batteries, comprising:
charging a plurality of batteries;
monitoring a temperatures of the plurality of batteries during charging; and
derating at least one of the plurality of batteries based on the temperatures of the plurality of batteries,
wherein derating the at least one of the plurality of batteries is effected using at least one equation defining at least one battery parameter.
